(19) United States
(12) Patent Application Publication
(10) Pub. No.: US 2011/0213569 A1
(43) Pub. Date: Sep. 1, 2011

(54) METHOD AND DEVICE FOR DETECTING CRACKS IN COMPRESSOR BLADES

(75) Inventors: Michael Zielinski, Unterschleissheim (DE); Gerhard Ziller, Dachau (DE)

(73) Assignee: MTU AERO ENGINES GMBH, München (DE)

(21) Appl. No.: 13/127,277

(22) PCT Filed: Nov. 10, 2009
(86) PCT No.: PCT/DE2009/001599

§ 371 Date: May 3, 2011

(30) Foreign Application Priority Data
Nov. 15, 2008 (DE) 10 2008 057 556.9

(51) Int. Cl. G06F 19/00; G01B 5/28

(52) U.S. Cl. 702/38; 702/35; 702/39

(57) ABSTRACT

A detection device for detecting cracks in compressor blades, having non-contacting sensors distributed in several planes and disposed in the vicinity of the rotor detects cycle times of blades at the sensors and/or relative and absolute changes in a gap width between a blade and the compressor housing. The captured data are compared to corresponding reference data in a memory device and analyzed.

The present invention relates to a method and a device for detecting cracks in compressor blades, and in particular, for detecting cracks in compressor blades in turbo engines by lengthwise and “unwinding” measurements on the blades.

When turbo engines are used, such as, e.g., in airplane engines or in industrial gas turbines, the detection of cracks in blades is of great importance, since cracks may arise with high vibration amplitudes and can cause serious damage as a consequence.

The destruction of a blade for the most part leads to the total loss of an engine, which leads to added costs and delays during engine development in mass production, but above all means a high risk for passengers or workers.

Different methods for detecting cracks for application in turbo engines are known from the prior art.

Such a method is based on the observation that vibration frequencies of the blades are reduced when a crack occurs.

At the beginning of a test series, the undamaged rotor will pass through a suitable vibration resonance, and the position of this resonance will be measured precisely for the individual blades. Later, further cycles will be recorded regularly under the same conditions and the deviation of the resonance positions from those of the reference cycle will be determined.

Another method for detecting cracks utilizes the circumstance that blades deform differently after a superficial crack in the centrifugal force field and under aerodynamic load than they do in the undamaged state.

In order to measure this change, the relative positions of the blade tips on the developed rotor profile will be calculated from the time data of blades passing underneath sensors built into the housing. These measurements are also conducted in comparison to a reference cycle with undamaged blades. Blade cracks are expressed by deviations from the reference positions.

It is a disadvantage in the case of the resonance position method that the resonance positions are distributed as a function of the precise operating conditions of the engine. Even if the measurement cycles are always conducted under the same conditions, slight scatter still occurs in the vibration frequencies.

On the other hand, experience shows that at least in the case of fundamental vibration modes and cracks in the lower region of the blade, frequency shifts can occur rapidly in a magnitude that can be measured without problem. However, cracking positions are also possible, which either only slightly influence the vibration frequency of a resonance or do not influence it at all.

Temperature-dependent frequency shifts represent another aspect. These can be subtracted, of course, but only as accurately as the temperature of the blades is known.

Alternatively, the individual blade distributions of the measurement cycle and the reference cycle can be placed onto the same mean value. This is problematical if all blades crack simultaneously, which may happen, e.g., in the case of a serious pump surge.

A disadvantage of the above-described blade position method is that the method is not capable of providing information when all blades crack simultaneously and as a consequence all blades are equally warped. This is not the case if measurement is made against a signal from the rotor shaft. This in turn has the disadvantage, however, that shaft pulses provide a poor time resolution due to the small diameter of the shaft, i.e., the resolution of the method will be poorer overall.

Therefore, possibilities are sought for the early detection of blade cracks, in order to be able to apply suitable measures before greater damage occurs. In detecting cracks, however, it is also a critical factor that false alarms do not occur, since this would lead to useless additional costs and with a view toward application in serial manufacture would rapidly destroy trust in the crack detection method.

Therefore, it is a problem of the present invention to provide an improved device and an improved method for detecting cracks in compressor blades.

This problem is solved by a device according to claim 1 and claim 2, as well as by a method according to claim 6 and claim 7.

Additional features and preferred enhancements are presented in the dependent claims.

According to a first aspect of the present invention, a device for detecting cracks in a compressor blade is provided, which comprises a detection device with a plurality of non-contacting sensors distributed in several planes, which are disposed in the vicinity of the rotor, for detecting cycle times of blades at the sensors; a memory device, in which data of reference cycles are stored under different conditions and rpm's; and an analytical unit for comparing the data captured by the detection device to corresponding data from the memory device.

According to a second aspect of the present invention, a device for detecting cracks in a compressor blade is provided, which comprises a detection device with a plurality of non-contacting sensors distributed in several planes, which are disposed in the vicinity of the rotor, for detecting relative and absolute changes in a gap width between a blade and the compressor housing; a memory device, in which data of reference cycles are stored under different conditions and rpm's; and an analytical unit for comparing the data captured by the detection device to corresponding data from the memory device.

Preferably, the sensors are distributed in three planes, whereby a first plane is found in the region of the front edge of the blades, a second plane is found in the region of the blade center, and a third plane is found in the region of the back edge of the blades.

In addition, the detection device carries out an absolute measurement, in which one of the outputs of the sensors in one of the three planes serves as the zero point for the sensors of the other two planes.

The sensors are preferably designed as capacitive, magnetic, eddy-current or microwave sensors.

According to a third aspect of the present invention, a method for detecting cracks in a compressor blade is provided, wherein cycle times of blades at the sensors are detected by a plurality of non-contacting sensors distributed in several planes, these sensors being disposed in the vicinity of the rotor, and the sensors compare the data captured in the detection to corresponding data from a memory device, whereby data of reference cycles under different conditions and rpm's are stored in the memory device.

According to a fourth aspect of the present invention, a method for detecting cracks in a compressor blade is provided, whereby relative and absolute changes in a gap width between a blade and the compressor housing are detected by a plurality of non-contacting sensors in several planes, these sensors being disposed in the vicinity of the rotor, and the data captured in the detection are compared to corresponding data from a memory device, whereby data of reference cycles under different conditions and rpms are stored in the memory device.

According to a fifth aspect of the present invention, a system for detecting cracks in a compressor blade is provided, this system comprising a device according to the first aspect of the present invention and a device according to the second aspect of the invention.

The subject of the present invention will become apparent based on the following description of a preferred example of embodiment, which is explained with reference to the appended drawing.

In the drawing:

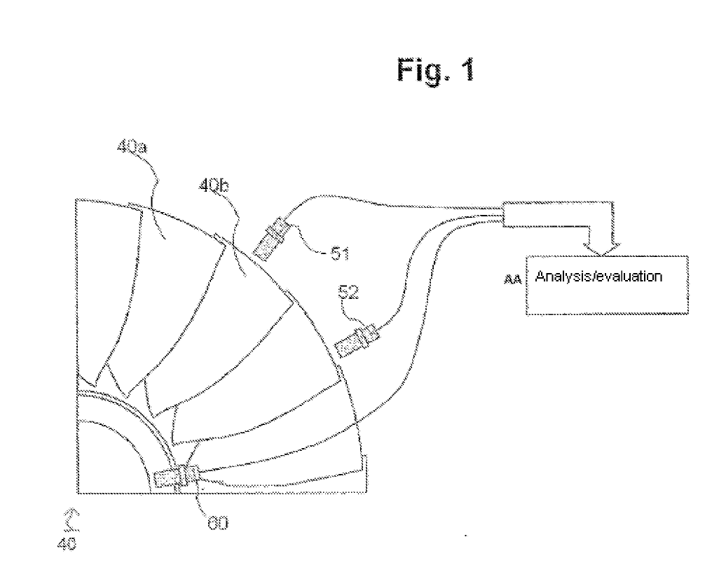

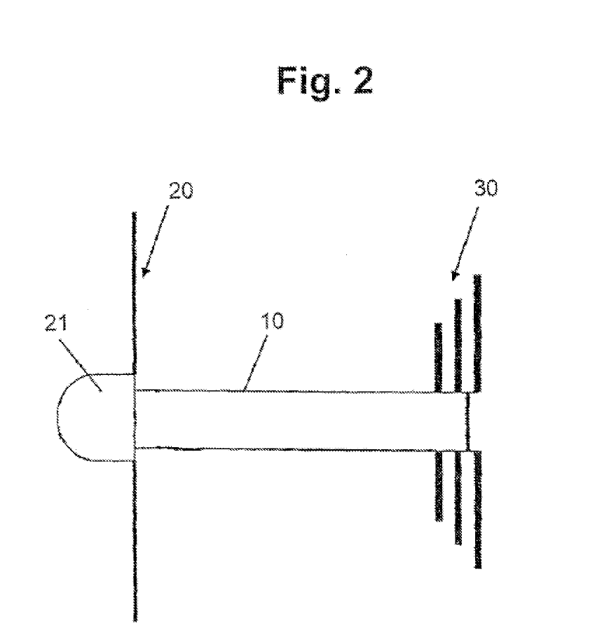

FIG. 1 shows a diagram of the principle of a non-contacting blade vibration measurement with capacitive sensors according to an example of embodiment.

According to the present invention, a device is provided for the non-contact measurement of vibration and of gaps, which uses capacitive sensors in the engine housing above the rotors, both for the vibration measurement as well as also for the radial gap measurement on the blades of axial compressors.

In place of capacitive sensors, other sensors may also be used, such as, for example, magnetic sensors, eddy-current sensors or microwave sensors.

The basic principle of the vibration measurement is a cycle time measurement, wherein vibrating blades pass by the sensors early or late, depending on their instantaneous deflection state.

The gap information is inserted in the variation of the signal amplitude when the blades pass under a probe. Vibration frequencies, vibration amplitudes and radial gaps of all blades of a rotor stage can be determined by an analysis of the cycle times and the variation in signal amplitudes.

Capacitive sensors 51, 52 finally supply the cycle times of the blades at the sensors and the gap between the blade tips and the compressor housing.

FIG. 1 shows an excerpt from a compressor stage 40 having a plurality of compressor blades 40a, 40b. Capacitive sensors 51, 52 that can detect the cycles of the blades are disposed at a specific distance. In this case, the cycle times of the blades fluctuate when vibrations occur, whereby the fluctuations depend on the vibration frequency as well as the vibration amplitude.

In addition, as is shown in FIG. 1, a sensor 60 is introduced, which delivers one pulse per revolution, whereby the values detected by sensors 51, 52 can be correlated with this pulse.

In order to be able to detect as many vibration modes as possible and in this connection to minimize the problems with vibration nodes at the blade tips—a sensor does not see this vibration at a vibration node—, the sensors are not disposed in one plane above the rotor, but are typically distributed in three planes, one next to the front edge, one in the region of the blade center and a third next to the back edge of the blade. This arrangement results in being able to obtain more information on potential blade cracks.

A method according to a first example of embodiment represents a broadening of the blade position method. Here, however, the relative positions of the blades to one another are not determined and compared with a reference cycle, but rather the positions of the front edge, center and back edge for each blade are determined relative to one another.

Thus, the step angle of each blade is measured roughly and compared with the value of the reference cycle.

This is an absolute measurement, since one of the three measurement values of each blade can be viewed as the zero point for the other two measurement values. If all blades crack simultaneously, the step angles of all blades change, and this is then also detected by the method.

A method according to a second example of embodiment uses gap measurement data. It is based on the assumption that the length of a blade in the centrifugal force field changes with a crack, and thus the gap relative to the housing also changes.

Again, the blade length profile of the intact rotor is measured for a reference cycle under defined conditions and then the results of later measurement cycles are compared with the reference profile. A blade crack is made noticeable by a relative and absolute reduction of the gap or by a lengthening of the blade. This measurement can be conducted on all axial measurement planes, so that the method is also sensitive when the crack only has an effect at the front edge or only at the back edge of the blade.

Another positive aspect of this method is that cracks that influence the frequency of a resonance only slightly can be detected with it, e.g., a crack that is produced by a higher vibration mode in the upper part of the blade and has no effect on the frequency of a resonance of a fundamental mode, thus roughly of the first bending mode or of the first torsional mode of the blade.

Disk cracks can also be detected. Depending on how the crack passes into the disk each time, the radial position and the circumferential position of the blades changes due to the crack in the region of the crack when compared to the undisturbed state. On the other hand, a crack in the disk can also influence the balancing status of the rotor. It can lead to rotor orbiting, a more or less circular radial movement of the rotor axis relative to the housing axis.

Likewise, all of the above methods can be used simultaneously, i.e., resonance position, blade position, blade “unwinding”, blade length and rotor orbiting can all be taken into consideration. Taken together, these provide a high reliability for detecting blade cracks and disk cracks.

In recording reference cycles, data can be recorded under different conditions or rpm's with constant or variable rpm. In addition, the recording system can be designed as a learning system for serial applications, in which reference profiles are automatically recorded and are filed in a continually expanding library. Consequently, updated messages are continually introduced automatically and can be compared with the appropriate reference cycles in the library.

Calculations of theoretical changes in frequencies, blade positions, blade lengths and balancing status for different crack positions and crack length can be conducted based on a blade model or blade-disk model, and alarm levels can be defined. Optimized system settings, such as, e.g., sensor positions or resonances can be derived therefrom.

It is also true that the measurement accuracy or the sensitivity of the measurement method increases with the number of probes used.

1. A device for detecting cracks in compressor blades, having:
a detection device with non-contacting sensors distributed in one or more planes perpendicular to the axis of the turbo engine, these sensors being disposed in the vicinity of the rotor, for detecting cycle times of blades at the sensors;
a memory device, in which data of reference cycles under different conditions and rpm's are stored; and
an analytical unit for comparing the data captured by the detection device to corresponding data from the memory device.

2. A device for detecting cracks in compressor blades, having:
a detection device with non-contacting sensors distributed in one or more planes perpendicular to the axis of the turbo engine, these sensors being disposed in the vicinity of the rotor, for detecting relative and absolute changes in a gap width between a blade and the compressor housing;
a memory device, in which data of reference cycles under different conditions and rpm's are stored; and
an analytical unit for comparing the data captured by the detection device to corresponding data from the memory device.

3. The device according to claim 1, wherein the sensors are distributed in three planes, wherein a first plane is found in the region of the front edge of the blades, a second plane is found in the region of the blade center, and a third plane is found in the region of the back edge of the blades.

4. The device according to claim 3, wherein the detection device carries out an absolute measurement, in which one of the outputs of the sensors in one of the three planes serves as the zero point for the sensors of the other two planes.

5. The device according to claim 1, wherein the sensors are selected from the group consisting of capacitive, magnetic, eddy-current and microwave sensors.

6. A method for detecting cracks in compressor blades of a turbo engine, having the steps:
detecting cycle times of blades at the sensors employing non-contacting sensors distributed in one or more planes perpendicular to the axis of the turbo engine, these sensors being disposed in the vicinity of the rotor; and
comparing the data captured in the detection step to corresponding data from a memory device, wherein data of reference cycles under different conditions and rpm's are stored in the memory device.

7. A method for detecting cracks in compressor blades of a turbo engine, having the steps:
detecting relative and absolute changes in a gap width between a blade and the compressor housing employing non-contacting sensors distributed in one or more planes perpendicular to the axis of the turbo engine; and
comparing the data captured in the detection step to corresponding data from a memory device, wherein data of reference cycles under different conditions and rpm's are stored in the memory device.

8. The method according to claim 6, wherein the sensors are distributed in three planes, wherein a first plane is found in the region of the front edge of the blades, a second plane is found in the region of the blade center, and a third plane is found in the region of the back edge of the blades.

9. The method according to claim 8, wherein an absolute measurement is carried out in the detection, in which one of the outputs of the sensors in one of the three planes serves as the zero point for the sensors of the other two planes.

10. The method according to claim 6, wherein the sensors are selected from the group consisting of capacitive, magnetic, eddy-current and microwave sensors.
